(19) United States
(12) Patent Application Publication
(10) Pub. No.: US 2012/0130725 A1
(43) Pub. Date: May 24, 2012

(54) AUTOMATIC UPGRADE SCHEDULING

(75) Inventors: Matthew Cooper, Issaquah, WA (US); Marshall Bjerke, Bellevue, WA (US); Robert Tobkes, Seattle, WA (US); Douglas Moy, Redmond, WA (US)

(73) Assignee: Microsoft Corporation, Redmond, WA (US)

(21) Appl. No.: 12/951,445

(22) Filed: Nov. 22, 2010

(51) Int. Cl. G06Q 10/00

(52) U.S. Cl. 705/1.1

(57) ABSTRACT

Automatic system upgrades are provided to a customer by a service provider based on the customer's preferences and parameters. The automatic upgrade system may manage customer preferences for the scheduling of automatic upgrades according to parameters such as date, time, and capacity. The upgrade system may automatically provide system upgrades to customer systems according to the customer preferences taking into account system health and status, customer parameters, and customer priority as determined by the service provider.

### BACKGROUND

System upgrades are often provided in computing and consumer electronic environments in order to replace hardware, software and firmware with newer and better versions to bring systems up to date or to improve the system's operability and characteristics. Common upgrades may include replacing operating systems or software programs, installing additional memory, installing new versions of software, updating security or virus programs, and providing patches. Patches may typically be downloaded to provide a small fix or update, but not an entire new version of software, and they usually aim to improve functionality or solve security issues.

Users often use online service providers for regularly and automatically maintaining IT infrastructures and providing security updates and software patches. However, customers often do not use online service providers for major system upgrades, since system upgrades can be complicated when taking into consideration scheduling issues, training, compatibility, and compliance issues. With conventional service providers, upgrades may be scheduled by the service provider with no input from a customer, such that an upgrade is performed at an inconvenient time for the customer. In other upgrade situations, a customer may have the option to instantly upgrade at their convenience by selecting an immediate initiation of a system upgrade, but may not be able to schedule an upgrade at a future time or date.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing an automatic upgrade management system which may allow customers to specify user preferences to a service provider regarding parameters for automatic system upgrades and times for scheduling upgrades. The automatic upgrade system may manage customer preferences for the scheduling of automatic upgrades according to parameters including date, time, and capacity. The upgrade system may automatically provide system upgrades to customer systems according to customer preferences taking into account the system's health and status, and customer priority as determined by the service provider.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates a service provider environment, where embodiments may be implemented;

FIG. 2 illustrates an example of an automatic upgrade system environment according to embodiments;

FIG. 3 illustrates an example of an automatic upgrade system according to embodiments;

FIG. 4 is a networked environment, where an automatic upgrade system according to embodiments may be implemented;

FIG. 5 is a block diagram of an example automatic upgrade system environment, where embodiments may be implemented;

FIG. 6 illustrates a logic flow diagram for a process of scheduling automatic upgrades of customer systems according to embodiments;

### DETAILED DESCRIPTION

As briefly described above, automatic system upgrades may be provided to a customer by a service provider based on customer preferences and parameters. The automatic upgrade system may manage customer preferences for the scheduling of automatic upgrades according to parameters such as date, time, and capacity, and the upgrade system may automatically provide system upgrades to customer systems taking into account system health and status, customer preferences and customer priority as determined by the service provider. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a server or similar computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing automatic upgrades to customer systems according to customer preferences. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

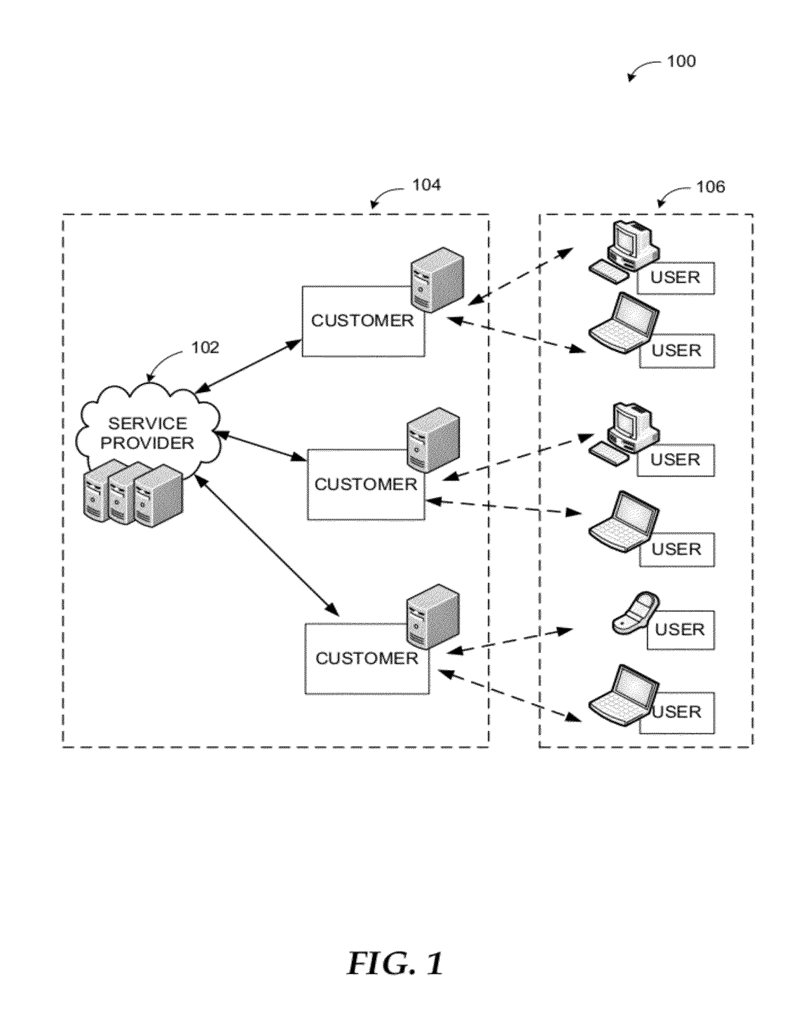

Referring to FIG. 1, diagram 100 illustrates an automatic upgrade system environment where embodiments may be implemented. As FIG. 1 illustrates, a hosted service provider 102 may be responsible for managing IT infrastructure and providing software, hardware, and/or firmware upgrades, security updates, and system patches to customers 104. Customers 104 may include, but are not limited to, hosted online services, collaborative authoring environments, application hosting service, software hosting environments, and individual users. Local end-users 106 may use online hosting services to host and access software in their business and personal computing environments through customers 104. According to some implementations, customer-specific hardware and software may reside at the hosting service provider's premises. Thus, service provider 102 may encompass customers 104.

Service provider 102 may provide updates and upgrades to the systems of customers 104 including software, hardware, and/or firmware. In conventional systems customers 104 may select upgrades for installation on their systems as the upgrades become available by manually selecting instant upgrade at convenient times for the individual customers. The customer(s) may choose the instant upgrade time taking into account scheduling, compatibility and compliance issues. In other cases, customers 104 may elect to have the service provider 102 automatically install system upgrades as they become available, however, the customer 104 may have limited or no input as to the timing of the installation, and the installation may occur at inconvenient times or occur before the customer 104 has been trained or prepared for the upgrade. Such restrictive upgrades may cause compatibility and compliance issues with other software, hardware, and/or firmware being used in a customer system.

An automatic upgrade system according to embodiments may enable customers 104 and/or local end-users 106 to communicate preferences for scheduling automatic system upgrades to the service provider 102 such that the service provider 102 may schedule automatic upgrades to customer systems according to the customer's preferences. The upgrade system may provide a service that customers 104 may use to interact with the service provider 102 to receive notifications about upcoming upgrades, their availability, features, and similar technical issues, as well as to set preferences for automatic system upgrades so that upgrades are scheduled at convenient/preferred times for the individual customers 104 and meet compliance and compatibility requirements. The upgrade system may also employ a mechanism for collecting and managing the customer preferences for scheduling system upgrades, and for communicating with an upgrade application to initiate and perform the upgrade installation process.

The example systems in FIG. 1 have been described with specific servers, client devices, applications, and interactions. Embodiments are not limited to systems according to these example configurations. A system providing automatic system updates to customer systems according to customer preferences may be implemented in configurations employing fewer or additional components and performing other tasks. Furthermore, specific protocols and/or interfaces may be implemented in a similar manner using the principles described herein.

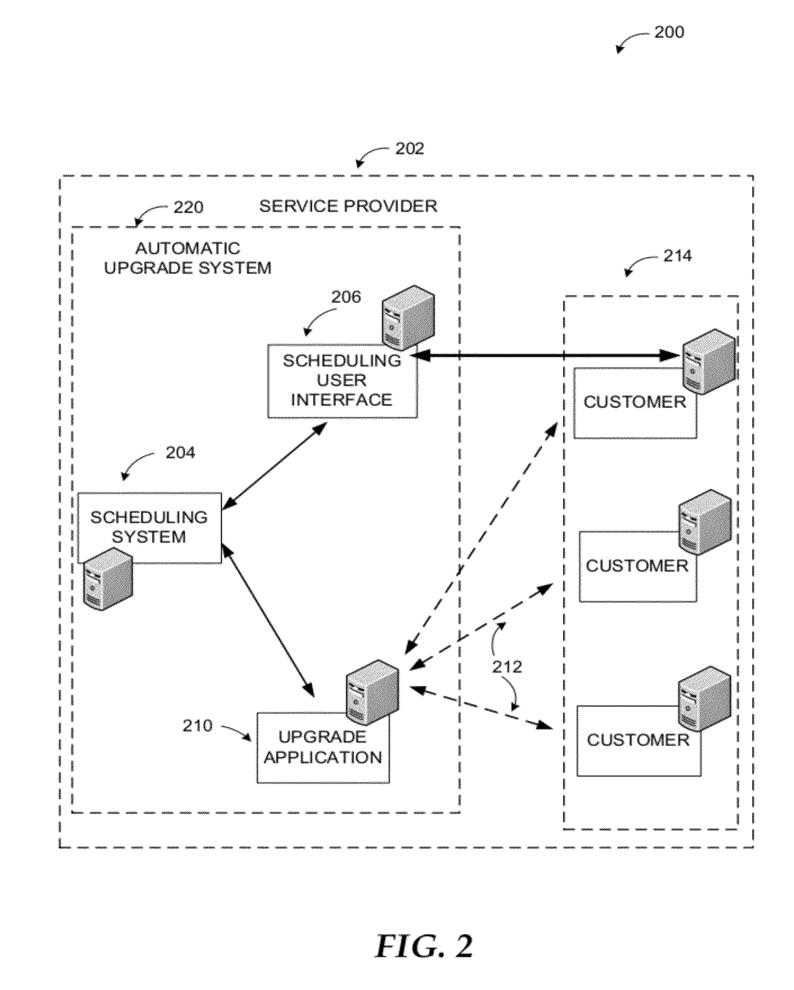

FIG. 2 illustrates an example automatic upgrade system according to embodiments. Embodiments may be implemented through a service provider 202 capable of providing system upgrades to customers 214 including software, firmware, and/or hardware updates and upgrades. The service provider, user interfaces, and applications shown in diagram 200 are for illustration purposes only. As demonstrated in FIG. 2, an automatic upgrade system 200 may enable a customer 214 to interact with a service provider 202 in order to schedule convenient automatic upgrades to customer systems. The automatic upgrade system 220 may track and manage the customer preferences for scheduling automatic system upgrades and may fulfill the customer preferences by automatically performing the customer's system upgrades at the scheduled time. As discussed above, service provider 202 may encompass customers 214.

According to some embodiments, the automatic upgrade system 220 may provide a scheduling user interface 206, through which the customer 214 may interact with the service provider 202 to receive information about upcoming upgrades, to set preferences for scheduling upgrades, and to receive other notifications. The service provider 202 may inform customer 214 about upcoming upgrades, for example advertising which software/hardware/firmware packages will become available, when, and with which feature sets. Additional information may include compatibility with existing systems, available support, and similar ones. The service provider 202 may also provide a list of available appointment timeslots to the customer over the scheduling user interface 206, which may include a date, a time, and a capacity for each timeslot. The capacity of a timeslot may indicate the maximum number of upgrade requests that the service provider 202 reasonably can fulfill in an appointment timeslot.

According to other embodiments, a scheduling system 204 may be responsible for determining available appointment timeslots to present to the customer 214. An appointment timeslot may be determined to be available if the service provider 202 has specified that an appointment timeslot for system upgrades exists and occurs at a particular time, and if there is at least a minimum level of capacity remaining, depending on the other upgrade requests for the same appointment time and the reasonable capability for the service provider 202 to fulfill the upgrades within the appointment timeslot. The scheduling user interface 206 may present the available appointment timeslots to the customer 214. The service provider 202 may determine the capacity of upgrades allowed in an appointment timeslot based on a variety of criteria such as, for example, the quantity of upgrade requests for that appointment timeslot or the type of upgrade requests since some upgrades may require more computing power by the service provider 202. The customer 214 may browse the available appointment timeslots over the scheduling user interface 206, and indicate an appointment timeslot as a preferred time for automatic upgrade. When an available appointment timeslot is selected by a customer 214, the capacity of that appointment timeslot may be reduced based on the predefined capacity determined by the service provider 202. Once the capacity of an available appointment timeslot is depleted, the appointment timeslot may become unavailable, and the scheduling system 204 may no longer present the appointment timeslot to other customers over the scheduling user interface 206.

According to further embodiments, the customer 214 may be enabled to select a preferred appointment timeslot and at least one alternate appointment timeslot. An appointment may not be a guaranteed time for automatic system upgrade by the service provider 202, so one or more alternate appointment timeslots may be selected for system upgrades in the event that the service provider 202 determines that the system upgrade may not be accomplished in a customer's 214 preferred appointment timeslot. In one embodiment, the service provider 202 may set restrictions on the selection of preferred and alternate appointment timeslots by the customer 214.

In another embodiment, the scheduling system 204 may present available timeslots with the first available appointment being a minimum number of days from the current time. The service provider 202 may configure the minimum number of days allowable between the current time and the first available appointment timeslot to allow sufficient time for scheduling, processing, and notifications by the automatic upgrade system 220. For example, if a customer is presented with available timeslots on a Monday, the first available appointment timeslot may be Saturday if the service provider 202 has configured 5 days as the minimum number of days allowable between the current time and the first available appointment timeslot.

Additionally, the service provider 202 may configure a minimum number of days allowable between a preferred appointment timeslot and one or more alternate timeslots. For example, if a preferred timeslot is selected on Monday November 1^{st}, the first available alternate timeslot may be Monday November 8^{th} if the service provider 202 has configured one week as the minimum number of days allowable between the preferred timeslot and the alternate timeslot. A minimum period of time between a preferred appointment timeslot and alternate appointment timeslots may allow the service provider 202 to address code bugs or other problems and to investigate and determine reasons for potential upgrade failures on the first try. The service provider 202 may configure any range of days between the current time, a preferred timeslot, and alternate timeslots.

According to yet other embodiments, the scheduling user interface 206 may present a list of all available upgrades by the service provider 202 for customer systems 214, and may enable the customer to schedule an automatic upgrade individually for each available upgrade, or to choose to not automatically upgrade and decide to upgrade at a later time. Additionally, in a further embodiment, the scheduling system 204 may allow a customer 214 to define a range of all available times to automatically upgrade the customer's system or to install one or more upgrades as they become available. For example, a customer 214 may select that any night between 12:00 am and 5:00 am or any Sunday is a preferred timeslot for automatic upgrades by the service provider 202.

The scheduling system 204 may also manage and store customer appointment timeslot preferences in an appointment database. The scheduling system 204 may track available system upgrades and customer requested appointment timeslots and monitor for scheduled actions to be taken, such as scheduled upgrades and customer notifications. When an automatic system upgrade is scheduled in a timeslot, the scheduling system 204 may select a customer for upgrade and may direct the upgrade application 210 to perform installation of the scheduled upgrade on the customer's system. A customer system may be selected for upgrade when the current time is within a customer's preferred or alternate appointment timeslot and there is enough capacity available as determined by the service provider 202 to perform the system upgrade.

Moreover, the service provider 202 may set additional parameters for selecting a customer for automatic upgrade including, for example, that there is enough time in an available timeslot to complete the system upgrade. In a further embodiment, a customer may be selected for upgrade during the customer's preferred or alternate appointment timeslot based on customer priority as determined by the scheduling system 204. A customer that is the highest priority may be selected first for system upgrade. A customer's priority may be determined by the service provider 202 based on the size, data complexity or other characteristics such as upgrade processing time, capacity and implementation. Furthermore, priority may be determined based on the preferred and alternate appointment timeslots selected by the customer. For example, if a customer has only one appointment scheduled with the scheduling system 204, that customer may be given a higher priority status since the presence of only one appointment implies that the preferred timeslot has passed and an alternate timeslot is not available or scheduled. Customers with two or more scheduled appointments may be given lower priority, because a future alternate scheduled timeslot may be available if the system upgrade cannot be completed in the current timeslot.

According to some embodiments, the scheduling system 204 may continuously monitor approaching appointment timeslots and send reminders or alerts to the customer 214 over the scheduling user interface 206 that an upgrade is scheduled for installation. An alert may include but is not limited to email, calendar alarm, text message or pop-up window reminder. The scheduling system 204 may configure any number of days as a standard reminder time period, or in an alternative embodiment a customer 214 may set the date, time and type of alert that the customer prefers to receive. Additionally, in a further environment, the scheduling system may send notifications 212 to a customer 214 alerting the customer as to the success of a system upgrade. For example, if a scheduled automatic upgrade is performed successfully by the upgrade application 210, the scheduling system may notify the customer 214 of the successful installation. Likewise, if an automatic system upgrade is not performed due to capacity or availability issues or if the upgrade fails for other reasons, the scheduling system may notify the customer 214 of the unsuccessful installation and may inform the customer that the alternative appointment timeslot will be scheduled or the user interface 206 may present additional alternative appointment timeslots for customer selection.

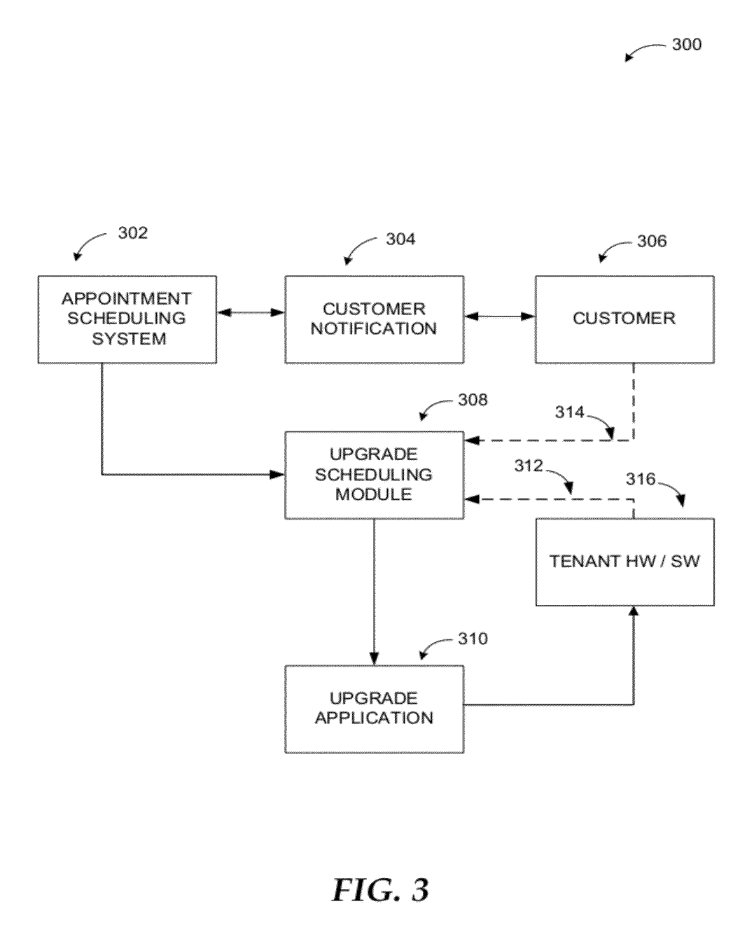

FIG. 3 illustrates another example environment for scheduling and performing automatic upgrades of customer systems. As demonstrated in diagram 300, the appointment scheduling system 302 may track and manage customer preferences for scheduling automatic system upgrades by upgrade scheduling module 308, may fulfill the customer preferences automatically performing the customer's system upgrades by an upgrade application 210 at the scheduled time, and may send notifications 304 to a customer 306 reminding the customer 306 of scheduled upgrades and informing the customer as to the success of the automatic upgrade.

In an example embodiment, the appointment scheduling system 302 may enable a customer 306 to interact with the upgrade scheduling module 308 to schedule preferred and alternative appointment timeslots for automatic system upgrades. The appointment scheduling system 302 may notify (304) the customer 306 of the available timeslots as determined by the service provider. When the customer selects one or more appointment timeslots, the upgrade scheduling module 308 may store the scheduled appointments in a scheduling database and may manage, track, and monitor all of the scheduled appointments for system upgrades. The appointment scheduling system 302 may send reminders or alerts to the customer 306 that an upgrade is scheduled for installation.

According to some embodiments, upgrade scheduling module 308 may operate to track the scheduled appointments and check for scheduled actions to be taken. The upgrade scheduling module 308 may determine that an automatic upgrade is scheduled to occur on a customer system and select a customer 306 to upgrade during the customer's scheduled appointment based on a variety of criteria, including but not limited to, scheduled appointment timeslot, system health and status, capacity of the server to upgrade, customer preferences and customer priority. If a customer is selected for upgrade, the upgrade scheduling module 308 may direct the installation of the system upgrade by upgrade application 310 of the tenant hardware and/or software 316. In a further embodiment, if a system upgrade is unsuccessful, a feedback loop 312 may cause the upgrade scheduling module 308 to reschedule the automatic upgrade for the customer's alternate update appointment timeslot. Optionally, customer 306 may schedule/reschedule the upgrade (314) directly as well. A notification 304 may be sent to the customer 306 to alert the customer of an unsuccessful system upgrade, and may alert the customer as to the next scheduled alternate appointment timeslot, or the appointment scheduling system 302 may provide a list of available timeslots for rescheduling an automatic update appointment. In a further embodiment, support personnel at service provider may schedule/reschedule the upgrade appointment(s) on behalf of the customer.

The examples in FIG. 1-3 have been described with specific elements, configurations, and scenarios. Embodiments are not limited to systems according to these example configurations. Providing automatic upgrades to customer systems according to customer preferences may be implemented in configurations using other types of elements, scenarios, and configurations in a similar manner using the principles described herein.

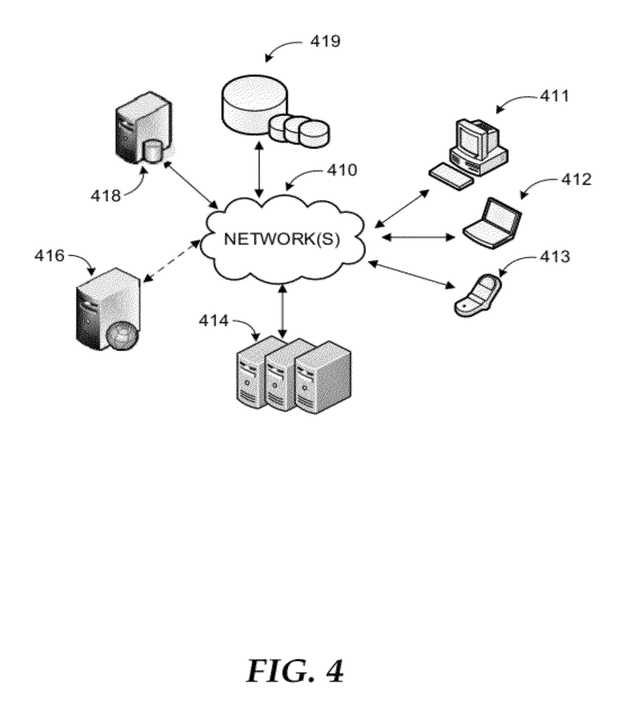

FIG. 4 is an example networked environment, where embodiments may be implemented. A system providing automatic upgrades to customer systems according to customer preferences may be implemented via software executed over one or more servers 414 such as a hosted service. The platform may communicate with client applications on individual computing devices such as a smart phone 413, a laptop computer 412, or desktop computer 411 (‘client devices’) through network(s) 410.

Client applications executed on any of the client devices 411-413 may facilitate communications via application(s) executed by servers 414, or on individual server 416. A configuration application executed on one of the servers may facilitate scheduling automatic upgrades to customer systems. The application may enable users to select available appointment timeslots for system upgrades, may provide notifications to customers as to upgrade status and scheduling options, and may perform automatic system upgrades according to customer preferences as discussed previously. The automatic upgrade system may retrieve relevant data from data store(s) 419 directly or through database server 418, and provide requested services (e.g. document editing) to the user(s) through client devices 411-413.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a platform providing automatic system upgrades for customers based on customer preference of scheduling. Furthermore, the networked environments discussed in FIG. 4 are for illustration purposes only. Embodiments are not limited to the example applications, modules, or processes.

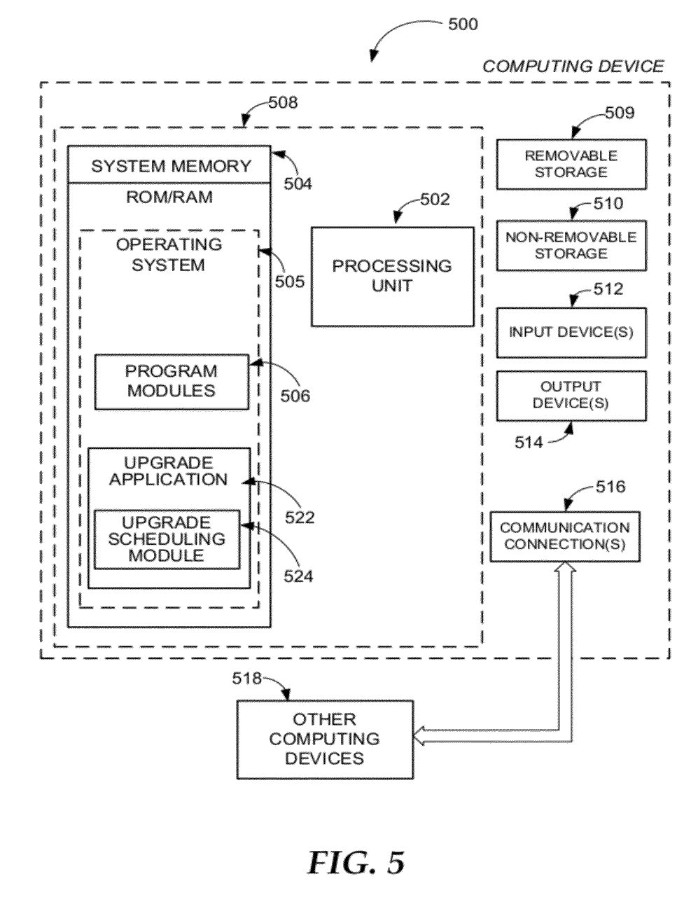

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing an application capable of scheduling automatic upgrades of customer systems according to embodiments and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, upgrade application 522, and upgrade scheduling module 524.

Application 522 may enable users to set preferences and schedule appointments for automatic system upgrades. Through a user interface controlled by configuration module 524, application 522 may display available appointment times to users and may send notifications and reminders to customers as to upgrade status and options. The upgrade scheduling module may track and manage all scheduled appointment timeslots for automatic upgrades and may select customers for the automatic installation of system upgrades. Application 522 and upgrade scheduling module 524 may be separate application or integrated modules of a hosted service. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wired or wireless network in a distributed computing environment, a satellite link, a cellular link, a short range network, and comparable mechanisms. Other devices 518 may include computer device(s) that execute communication applications, web servers, and comparable devices. Communication connection(s) 516 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

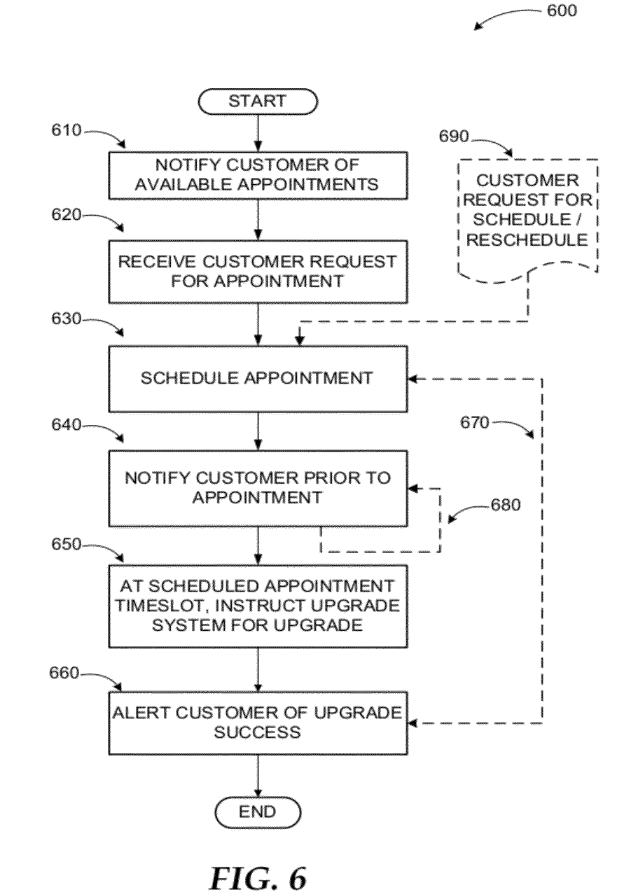

FIG. 6 illustrates a logic flow diagram for process 600 of providing automatic upgrades to customer systems according to customer preferences according to embodiments. Process 600 may be implemented on a server or other computing device.

Process 600 begins with operation 610, where available appointment timeslots may be determined by the service provider and may be presented to a customer for selection of a preferred appointment timeslot for automatic upgrades and at least one alternate appointment timeslot for automatic system upgrades. At operation 620, the system may receive the customer request for an appointment timeslot, and the system may determine if the requested timeslot is available based on the capacity of the timeslot. At operation 630, the system schedules the customer for automatic system upgrade in the database for a preferred appointment timeslot and one or more alternative appointment timeslots. alternatively, a customer may be enabled to schedule (or reschedule) an appointment directly or through a support person at the service provider, as shown by input operation 690 feeding in to operation 630.

Upon scheduling the appointment, at operation 640 the system may continually track and monitor the appointment database and at a time prior to the scheduled upgrade, as configured by the system or the customer, the system may send an alert or notification to the customer to remind the customer of the upcoming scheduled upgrade. Dashed loop 680 represents repeated notifications to the customer. For example, notifications about the pending upgrade may be sent 4 weeks, 2 weeks, and 1 week prior to the scheduled appointment date. When the current time is within a customer's appointment timeslot, at operation 650, the system may select a customer for upgrade according to the customer priority as determined by the service provider and alert the upgrade system to install the upgrade on the customer's system. At operation 660, the system may notify the customer of the success of the upgrade. If the upgrade is unsuccessful due to capacity issues or other problems, the system, through a feedback loop at operation 670, may reschedule the automatic upgrade for the customer's alternate appointment timeslot and continue the process for selecting a customer for upgrade and automatically upgrading the customer's system. An upgrade may involve, but is not limited to, operating systems, software programs, hardware, firmware, or combinations of those.

The operations included in process 600 are for illustration purposes. Providing automatic upgrades to customer systems according to customer preferences may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing an automatic upgrade management system, the method comprising:
providing available appointment options for scheduling an automatic system upgrade to a customer;
enabling the customer to select an available appointment for the automatic system upgrade;
storing and managing customer preferences for the automatic system upgrade appointment;
scheduling the automatic system upgrade at a customer requested appointment timeslot;
communicating with an upgrade application to perform the automatic system upgrade; and
upon successful installation of the system upgrade, notifying the customer of installation of the system upgrade.

2. The method of claim 1, further comprising:
enabling the customer to select a preferred appointment timeslot and at least one alternate appointment timeslot for the automatic system upgrade.

3. The method of claim 2, further comprising:
in response to an unsuccessful system upgrade, one of: providing alternative appointment timeslots for rescheduling the automatic system upgrade and rescheduling the automatic system upgrade at the at least one alternate appointment timeslot.

4. The method of claim 1, further comprising:
providing available appointment timeslots to the customer for scheduling the automatic system upgrade based on at least one from a set of: a date, a time, and a capacity of the timeslots, wherein the timeslots are configurable by a service provider, and the capacity is determined based on a maximum number of upgrade requests to be fulfilled in each appointment timeslot.

5. The method of claim 1, further comprising:
providing a notification to the customer to alert the customer that an automatic update is scheduled for installation, wherein the notification includes one or more of: an email, a text message, a pop-up window, and a calendar alert.

6. The method of claim 1, further comprising:
enabling the customer to select among one of: a range of dates/times and a recurring date/time for the appointment.

7. The method of claim 1, wherein providing available appointment options for scheduling the automatic system upgrades includes providing a list of available upgrades and enabling the customer to schedule one or more appointments for each individual upgrade.

8. The method of claim 1, further comprising:
monitoring and tracking available system upgrades and scheduled customer appointments for providing customer alerts notifications.

9. The method of claim 1, further comprising:
assigning a priority to each customer for scheduled automatic upgrades in a scheduled appointment timeslot; and
selecting a customer for the automatic system upgrade based on the assigned priority within the scheduled appointment timeslot.

10. The method of claim 1, wherein the priority is assigned based on at least one from a set of: a size of the system upgrade, a data complexity associated with the system upgrade, an upgrade processing time, and a capacity of the upgrade management system.

11. A server for providing an automatic upgrade management system, comprising:
a memory storing instructions;
a processor coupled to the memory, the processor executing an automatic upgrade scheduling application in conjunction with the instructions stored in the memory, wherein the automatic upgrade scheduling application is configured to:
provide available appointment options for scheduling an automatic system upgrade to a customer;
enable the customer to select an available appointment timeslot for the automatic system upgrade;
store customer preferences for the selected automatic system upgrade appointment;
schedule the automatic system upgrade at the customer selected appointment timeslots;
alert the customer prior to the scheduled automatic system upgrade;
direct an upgrade application to perform the system upgrade at the scheduled appointment timeslot; and
upon successful installation of the system upgrade, notify the customer of installation of the system upgrade.

12. The server of claim 11, wherein the automatic upgrade scheduling application is further configured to enable the customer to select at least one from a set of: a date, a time, a frequency, and a type of alert to be sent.

13. The server of claim 11, wherein the automatic upgrade scheduling application is further configured to provide a feedback loop to notify the customer of unsuccessful system upgrade and to automatically reschedule the system upgrade at an alternate appointment timeslot.

14. The server of claim 11, wherein the automatic upgrade scheduling application is further configured to:
present available appointment timeslots to the customer based on one of a time, a date, and a service provider capacity; and
enable the customer to select among one or more available appointment timeslots, a range of dates/times, and recurring appointment timeslots for scheduling the automatic system upgrade.

15. The server of claim 11, wherein the automatic upgrade scheduling application is further configured to determine a minimum number of days between a selected appointment timeslot and an alternate appointment timeslot for rescheduling the automatic system upgrade.

16. The server of claim 11, wherein the customer is a system serving a plurality of individual computing devices, and the automatic system upgrade comprises upgrade of at least one from a set of: software, firmware, and hardware.

17. A computer-readable storage medium with instructions stored thereon for providing an automatic upgrade management system, the instructions comprising:
providing available appointment options for scheduling an automatic system upgrade to a customer;
enabling the customer to select an available appointment timeslot for the automatic system upgrade and at least one alternate appointment timeslot;
storing customer preferences for the selected automatic system upgrade appointment;
scheduling the automatic system upgrade at the customer selected appointment timeslots;
notifying the customer prior to the scheduled automatic system upgrade;
directing an upgrade application to perform the system upgrade at the scheduled appointment timeslot;
upon successful installation of the system upgrade, notifying the customer of installation of the system upgrade; and
in response to an unsuccessful system upgrade, rescheduling the automatic system upgrade at the at least one alternate appointment timeslot.

18. The computer-readable medium of claim 17, wherein the instructions further comprise:
upon scheduling the system upgrade at the selected appointment timeslot, decreasing a capacity of the timeslot; and
upon depletion of the capacity of the timeslot, notifying the customer that the appointment timeslot is no longer available.

19. The computer-readable medium of claim 17, wherein the instructions further comprise:
enabling the customer to select notification settings for scheduled system upgrades and success of system upgrades based on at least one from a set of: a date, a time, and a type of notifications.

20. The computer-readable medium of claim 17, wherein the instructions further comprise:
performing the automatic system upgrade based on at least one from a set of: the scheduled appointment timeslot, a health and status of a server providing the system upgrade, a capacity of the server providing the system upgrade, a customer preference, and a customer priority.
